(19) United States
(12) Patent Application Publication
(10) Pub. No.: US 2010/0003136 A1
(43) Pub. Date: Jan. 7, 2010

(54) Windmill tower

(76) Inventor: Michael Anguelo, Miami Springs, FL (US)

Correspondence Address: Michaelanguelo-International Co., 733 Curtis Pkwy, Apt 1B, Miami Springs, FL, 33166, US

(21) Appl. No.: 12/168,113

(22) Filed: Jul. 5, 2008

(51) Int. Cl. F03D 3/02

(52) U.S. Cl. 416/120

(57) ABSTRACT

The Wind Mill Tower is a new concept of catching the wind force with more efficiency using the wind force at different levels the Wind Mill Tower consist in the superimposition of several nucleus connected by a main shaft to form a Tower of the vertical Wind Mill, because the atmosphere is compose of various layers of wind, as higher as more strong wind you get, that is the reason of multi modules.

Each unit rotate as its own by two ratchets, one on top and one in the bottom also a friction ball bearing underneath each unit to eliminate a friction between them. If the wind dies or is less powerful in certain level, that particular section of the tower idles because the ratchet, it will not make any resistance to the shaft, while the others keep pushing in a rotation motion the shaft generating constant power.

Each section assemble of the Wind Power Tower is composed of multiples concave-sails with a concave configuration, the two ratchets and the friction ball bearing, you superimpose vertically, as many units as you desire, more units more power higher tower the diameter and the height, is determine by the need of power, more diameters, more modules, more power. The concave-sails are constructed with strong and light material, as composed material or aluminum and maybe titanium, with the shape of a bird wing or a portion and shape of the wing of an airplane

The sails push the shaft on hundred degree, by the concave shape catching the wind power, while the other concave-sail in the opposite position, is coming against the wind by the counter-concave side, of the said sail, collapsed, not making a significant resistance to the wind, allowing the force of the wind affecting only one side. That same concave-sail, when get to the point “0” of the firth one hundred eighty degrees, the three hundred degree cycle is completing.

### CROSS-REFERENCE TO RELATED APPLICATION

There has been many patents concerning a wind device to produce electricity, as U.S. Pat. Nos. 7,215,037, 4,321,005, 7,425,776 and others, beside the no similarity, my invention has unique components that make my invention different to others.

### BACKGROUND OF THE INVENTION

1. Field of the Invention

The present invention relates to wind power recovery; more particularly the way the wind power is used to generate electricity using multi modules, staked one on top of another to form a Wind Mill Tower to generate electricity at any speed and any quantity

2. Description of the Prior Art

Conventional wind power mills usually are presented as a rotor facing the wind, with three or more propeller's blade, resembling an air craft without engine.

The rotor is extremely heavy, hard, costly to maintain and is not efficient in low wind speed.

The rotor has to be positioned facing the wind, in order to catch the wind force efficiently, when the wind is gusting from multi-directions, a great amount of energy is lost.

In the present invention all those factors is corrected and improved as I explain as follow:

### OBJECTIVE AND SUMMARY OF THE INVENTION

The primary objective of this invention provide a better more improved and reliable Apparatus to generate electricity using the power of the wind in a manner more economical and more efficient, than the present inventions.

Also another objective of The Wind Mill Tower is provide a different sizes of this apparatus, from a single module for a single home to the largest multi-modules apparatus to generate electricity to supply a city, in a farm field style, using multi Wind Mill Towers, all over the World, to help maintain clean air for all.

Another particularity that this invention has is the ability to catch the wind force in any directions that it's coming from, without the need of repositioning, it is always auto positioned in any direction, the wind is blowing.

The Wind Mill Tower is a vertical positioned apparatus with multi-modules positioned one on top of the other to assemble a Wind Mill Tower, each modules may be of different sizes composed of four or more concave sails, friction ball bearings, double shafts and ratchets, the Wind Mill Tower could be as high as permissible and as wide as possible, making this devise very versatile and efficient, constructed in aluminum, compose material, steel and other material of durable strength and affordable with a minimum maintenance at a specific size

Thus there has been outlined the most important features of this invention in order that the detailed description that follow may better understood and in order that the present contribution to the art may better appreciated. There are additional features of the invention hat will be described hereinafter and which will form the subject matter of the claims appended hereto.

In that respect, before explaining at least one embodiment of the invention in detail, it is to be understood that the invention is not limited in its arrangement of the components set forth in the following description and illustrated in the drawings. The invention is capable of others embodiments and of being practiced and carried out in various ways.

It is understood that the phraseology and terminology employed herein are for the purpose of description and should not be regarded as limiting in any aspect. Those skilled in the art will appreciate that the concept upon which this disclosure is based may readily be utilized as a basis for designing other structures, methods and systems for carrying out several purpose of this development. It is important that the claims be regarded as including such equivalent methods and products resulting therefrom that do not depart from the spirit and scope of the present invention. The application is neither intended to define the invention of the application, which is measured by its claims, nor to limit its scope in any way.

Thus objectives of the invention set forth above, along with various features of novelty, which characterize the invention, are noted with particularity in the claims annexed to and forming a part of this disclosure. For a better understanding of the invention, its operating advantage and the specific results obtained by it uses, reference should be made to the following detailed specification taken in conjunction with the accompanying drawings wherein like characters of reference designate like parts throughout the several views. The drawings are included to provide a further understanding of the invention and incorporated in and constitute a part of this specification. They illustrate embodiments of the Invention and, together with their description, serve to explain the principles of the invention.

An esthetic configuration resembling majestic towers, or round tall buildings in a city, preferable of a farm field configuration; but applicable to any circumstances, making a pleasant view to the community reassembling oil fields.

The modules of The Wind Mill Tower has a particular mechanism that others wind turbines doesn't have, it is very effective and works as follow:

When the vertical module (s) is rotating by the wind force, the first 180 degree, the wind is pushing the concave-sail forward catching the full force of the wind, in the second 180 degree the said sail travel backward against the wind direction, there is when the mechanism permit the collapsing of the concave-sail (s) permitting the wind flow against the concave configuration freely, causing a little resistance to the blowing wind causing that the right sail (s) received the full wind force, making it the only wind turbine that has such mechanism.

The Wind Mill Tower is supported by series of eight posts or tubing surrounded with a protecting strong mesh, with a size holes capable to prevent birds or any others flying objects get struck by the concave-sails and fine enough to permitted the wind pass though, without causing any significant obstruction. The posts are strong enough and securely attached round concrete base forming a circle of posts resembling an architectonic tower for an acceptable view to the community, the top will looks like a cupola, where at the center is the top support of the inner transmission bar that runs from the top to the bottom of the Tower, where an space between the first module and the base is reserved for the mechanism that will transmit the rotation to a conversion box and a generator to produce electricity

Thus there has been mentioned must of the more important feature of my invention in order that the detailed descriptions is with the propose of better understanding of the art

The invention is applicable to others embodiments and will be practice and carried out in various manners.

### BRIEF DESCRIPTIONS OF THE DRAWINGS

FIG. 1. Is an elevation schematic view of a multi modules Wind Tower electricity generator the present invention in the sample having three modules; but not limited.

FIG. 2 Full view and explanation of how The Wind Mill Tower operate

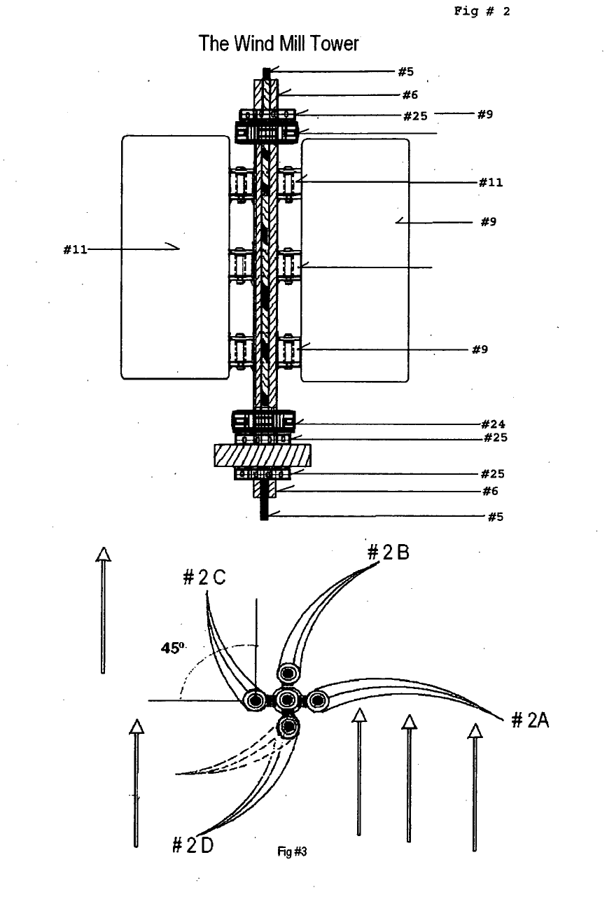

FIG. 3 Is a Top View of the Wind Mill showing the operation of the collapsed concave-sail when traveling against the wind and with eight support bars in hidden lines and concave-sails operation explanations

FIG. 4 Is a detail elevation schematic view of the sails with an operational explanation of how the wind flow is affecting the operation of the collapsing of the said concave-sail # 2C and the 90 degree said concave-sail # 2A

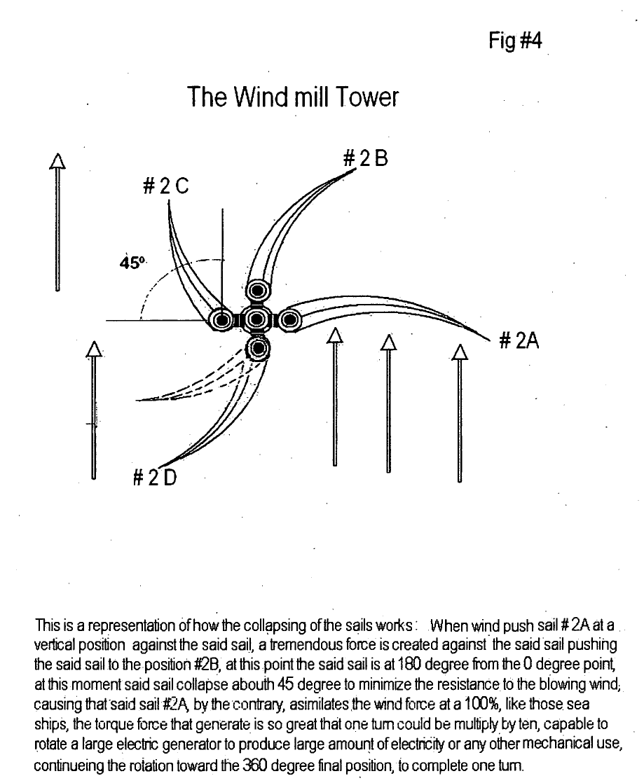

FIG. 5 Detail of sail, hinges with all the component and transmission bars of the Wind Mill Tower

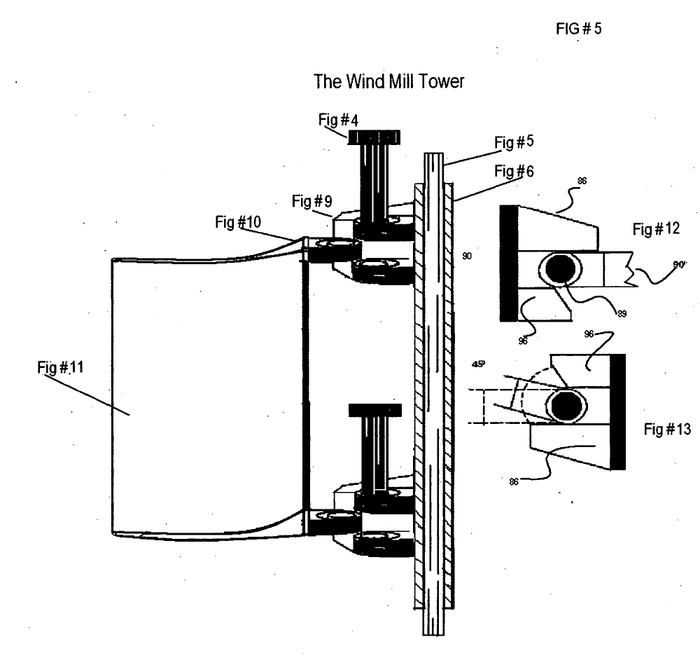

### DETAILING DESCRIPTION OF THE PREFERRED EMBODIMENT

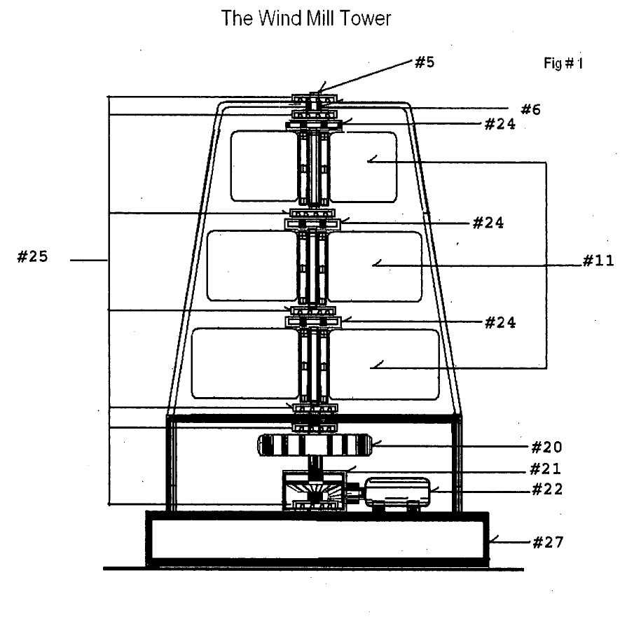

Referring to the drawing of the FIG. 1 shows the concave-sails #11 which is attached to a primary transmission tube # 6 by hinges # 9-10, a plurality of concave-sails # 11 are secured to the bar # 6 by hinges show in Detail #1, # 4, 5, 6, 9, 10 and FIG. 12, 13 in a fixed relationship. And ratchets #25 also friction ball-bearing #24 and bottom heavy duty fiction ball-bearing #23

In the second and third module are attached to the primary tube # 6, the same way.

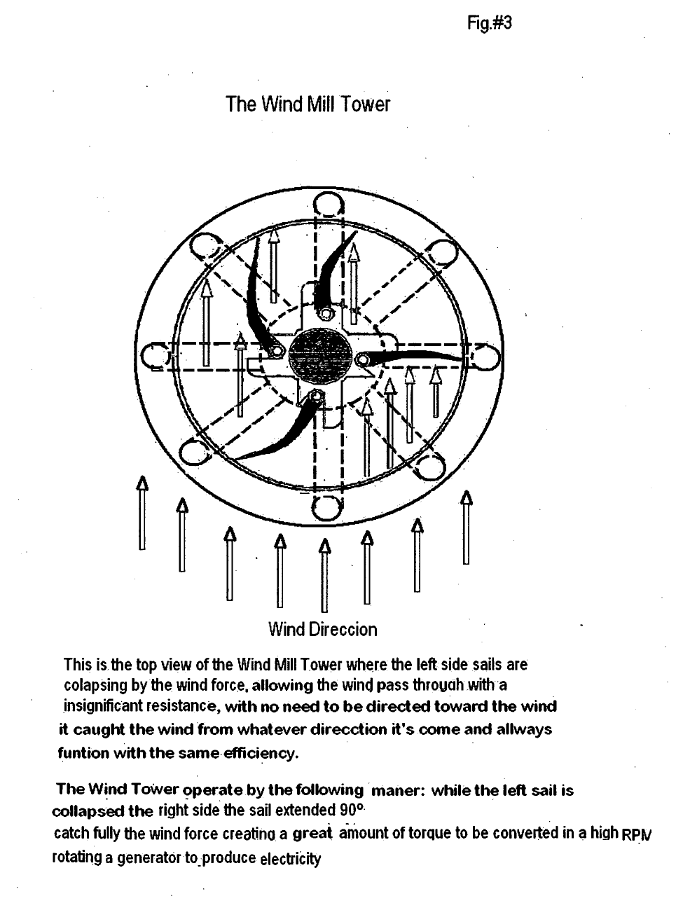

Also in the FIG. 1, the main central shaft #5, transmits the torque power to the flywheel #20 and to the gear case #21 to rotate the electricity generator #22. The structure is supported by eight tubes or columns # 26 around the base #27 as show in FIG. 3.

Each modules operate independently one from the other, when the wind force is less on any of the modules the others modules rotate freely, while the module that has less or no wind force stay still by the action of a ratchet the other modules keep pushing the sail by the force of the wind.

From the presiding, it can be seen that a multiple modules staked vertically positioned The Wind Mill Tower electricity generator system has been provided that it meet all the advantages of others art devices and offer additional advantage not heretofore achievable.

With respect to the forgoing invention, the optimum dimensional relationship to the parts of the invention including variation in size, materials, shape, form, function and manner of operation, use and assembly are deemed readily apparent to those skilled in art, and all equivalent relationships illustrated in the drawings and described in the specification are intended to be encompassed herein.

The foregoing is considered as illustrative only of the principles of the invention. Numerous modifications and changes will readily occur to those skilled in the art, and it is not desire to limit the invention to the exact construction and operation shown and described. All suitable modifications and equivalents that full within the scope of the appended claims are deemed within the present inventive concept.

Thus objectives of the invention set forth above, along with various features of novelty, which characterize the invention, are noted with particularity in the claims annexed to and forming a part of this disclosure. For a better understanding of the invention, its operating advantage and the specific results obtained by it uses, reference should be made to the following detailed specification taken in conjunction with the accompanying drawings wherein like characters of reference designate like parts throughout the several views.

The drawings are included to provide a further understanding of the invention and incorporated in and constitute a part of this specification. They illustrate embodiments of the invention and, together with their description, serve to explain the principles of the invention

What is claimed is:

1- A wind driven torque generating device comprising: four or more concave-sails wind driven rotatable, vertically positioned, forming a module to generate rotation force to promote electricity.

2- Each module is a independents unit and could be staked one on top of another forming a Wind Mill Tower, the sizes of each modules are, of different dimensions, said modules each comprising a plurality of concave-sails, each modules generate rotating force at different levels, with no need to be redirected or repositioned by any means or devices.

3- The device as claimed in claim -2- wherein the device responds to multidirectional wind flow without wind directional adjusting, each of the rotatable modules has a plurality of concave-sails connected to a central single rotating member.

4- The device claimed in claim -3- wherein each of the rotatable modules has circular ends to which the vertical concave-sail are firmly secured to the a vertical member, by collapsing hinges, ratchets and friction ball-bearing, so that the secured module rotate independently.

5. The device as claimed in claim -4- wherein all the modules are independent devices that rotate independently each from another.

6. The device claimed in claim -5- further comprising: a plurality of eight bars, forming a protection cage, for stability, surrounded by a mesh for preventing birds or others flying matters to collide against the moving concave-sails.

7. The device as claimed in claim -2- wherein the device responds to multidirectional wind flow without wind directional adjusting, each of the rotatable modules has a plurality of concave-sails connected to a central single rotating member, and each module rotate independently making this device more efficient.

8. A wind driven torque generating device comprising: four sails wind driven rotatable, vertically positioned, forming a plurality of modules to generate rotation force to promote electricity in many quantities.
